(19) United States
(12) Patent Application Publication
(10) Pub. No.: US 2006/0045296 A1
(43) Pub. Date: Mar. 2, 2006

(54) Ear picking device

(76) Inventor: Chung Min Liao, Taichung (TW)

Correspondence Address: Chung Min Liao, P.O. Box 63-99, Taichung, 406, TW

(21) Appl. No.: 10/918,676

(22) Filed: Aug. 16, 2004

(51) Int. Cl. H04R 25/00

(52) U.S. Cl. 381/312

(57) ABSTRACT

An ear picking device includes two or more arms having one end secured together with a coupling device, to allow the arms to be resiliently coupled together, and to allow other ends of the arms to be resiliently spaced away from each other. Two or more cotton members are attached onto the other ends of the arms, for engaging into external auditory meatus of users, and the cotton members may be resiliently spaced away from each other by the coupling device, for cleaning the external auditory meatus of users. Each of the arms may include an enlarged head disposed on the other ends. One or more spring elements may be coupled between the arms to increase a resilience of the arms.

### BACKGROUND OF THE INVENTION

1. Field of the Invention

The present invention relates to an ear picking device, and more particularly to an ear picking device having two or more picking members disposed on two or more spring arms, for resiliently engaging with and cleaning external auditory meatus of users.

2. Description of the Prior Art

Typical ear picking devices comprise a tubular plastic member or rod having one or more cotton materials attached to one or both ends thereof, for engaging into and for cleaning external auditory meatus of users.

Normally, the typical ear picking devices are required to be rotated completely around the external auditory meatus, for allowing the external auditory meatus to be suitably cleaned by the typical ear picking devices.

In addition, the typical ear picking devices comprise a single cotton material attached to one end of the tubular plastic rod which includes a small volume that may have a good chance to be deeply engaged into the external auditory meatus, and may have a good chance to hurt the tympanic membrane inadvertently.

The present invention has arisen to mitigate and/or obviate the afore-described disadvantages of the conventional ear picking devices.

### SUMMARY OF THE INVENTION

The primary objective of the present invention is to provide an ear picking device including two or more cotton members disposed on two or more spring arms, for resiliently engaging with and cleaning external auditory meatus of users and for allowing the external auditory meatus to be easily cleaned with the ear picking device.

The other objective of the present invention is to provide an ear picking device including two or more picking or cotton members disposed on two or more spring arms, for preventing the picking members from deeply engaging into the external auditory meatus and for preventing the tympanic membrane from being hurt by the ear picking device inadvertently.

In accordance with one aspect of the invention, there is provided an ear picking device comprising a first arm and at least one second arm including one end secured together with a coupling device, to allow the arms to be resiliently coupled together, and for allowing other ends of the arms to be resiliently spaced away from each other, and a first cotton member and at least one second cotton member attached onto the other ends of the arms, for engaging into external auditory meatus of users, and the first cotton member and the at least one second cotton member being resiliently spaced away from each other by the coupling device, for cleaning the external auditory meatus of users. The cotton members disposed on the free ends of the arms may thus be resiliently engaged with the external auditory meatus of users and for allowing the external auditory meatus to be easily cleaned with the ear picking device. In addition, the cotton members may be prevented from deeply engaging into the external auditory meatus, to prevent the tympanic membrane from being hurt by the ear picking device inadvertently.

The first arm and the at least one second arm each includes an enlarged head provided on the other ends thereof. Each of the heads includes a number of cavities formed therein, or includes a number of projections extended therefrom, for increasing an ear picking effect.

One or more spring elements may further be provided and coupled between the first arm and the at least one second arm, to increase a resilience of the first arm and the at least one second arm.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of an ear picking device in accordance with the present invention;

FIG. 2 is a perspective view illustrating the other arrangement of the ear picking device;

FIG. 3 is a partial exploded view illustrating another arrangement of the ear picking device;

FIG. 4 is a partial exploded view illustrating a further arrangement of the ear picking device;

FIG. 5 is a perspective view illustrating a still further arrangement of the ear picking device;

FIG. 6 is a perspective view illustrating a still further arrangement of the ear picking device;

FIG. 7 is a partial exploded view of the ear picking device as shown in FIG. 6; and

FIGS. 8 and 9 are plan schematic views illustrating the operation of the ear picking device.

### DETAILED DESCRIPTION OF THE PREFERRED EMBODIMENT

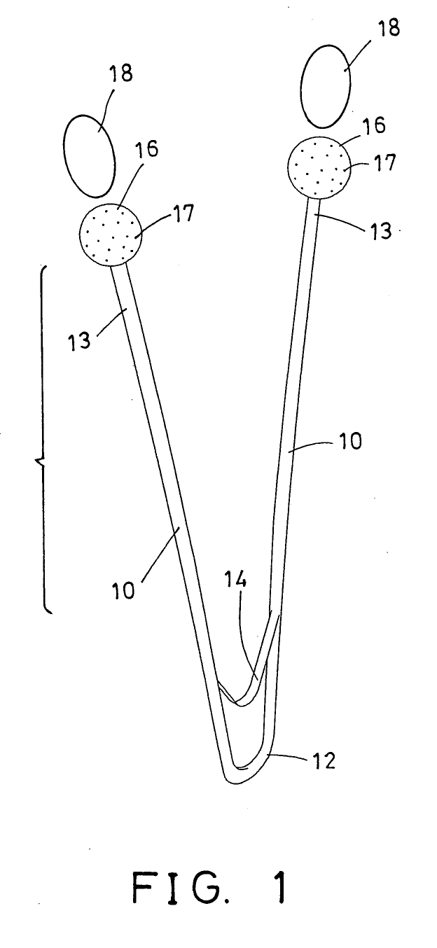

Referring to the drawings, and initially to FIG. 1, an ear picking device in accordance with the present invention comprises two (FIGS. 1-2 and 4-9) or more (FIG. 3) arms 10, such as spring arms 10, having one end secured together with a coupling portion or device 12, for allowing the arms 10 to be resiliently coupled together, and for allowing the other ends 13 of the arms 10 to be resiliently spaced away from each other.

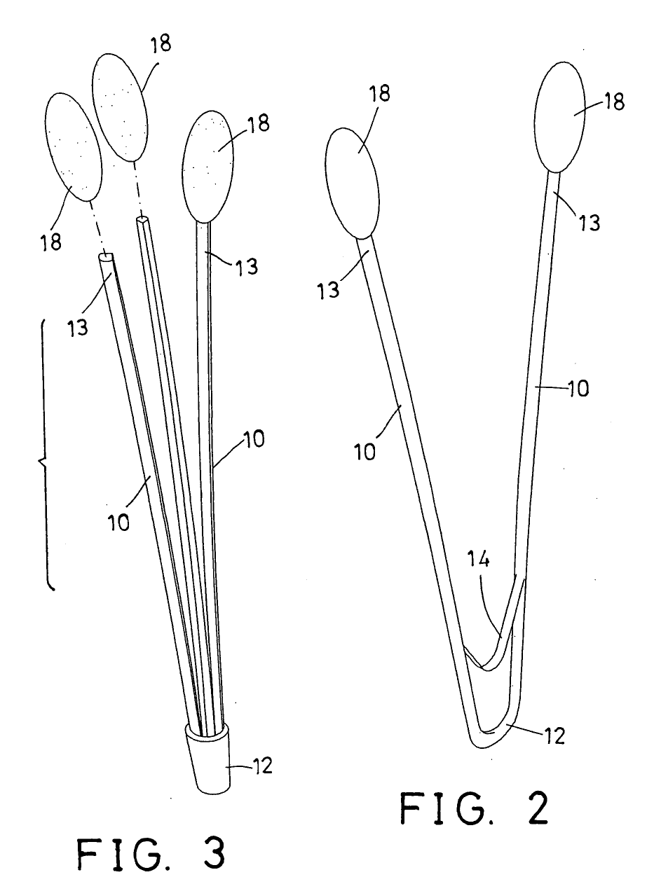

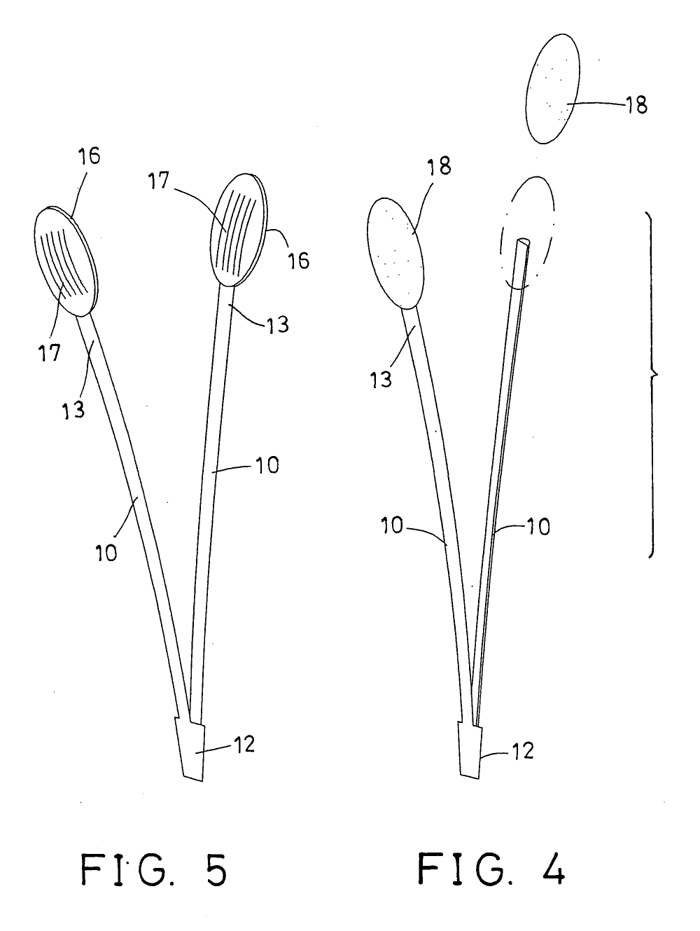

The arms 10 may include various kinds of cross section, such as circular, semi-circular (FIG. 4), rectangular (FIG. 3), or other shapes. The ear picking device may further include one or more spring blades or elements 14 disposed between the arms 10 (FIGS. 1, 2), to increase the resilience or the spring biasing force between the arms 10, and to increase a working life of the coupling portion or device 12.

Each of the arms 10 may include an enlarged head 16 formed or provided on the other ends 13 thereof, and each head 16 preferably includes a number of cavities or projections 17 (FIG. 1), in which the projections 17 may include dot-shape (FIG. 1), line shape (FIG. 5), or the like, for directly engaging with and for cleaning the external auditory meatus of the users. It is preferable that a sharp included angle is formed between the arms 10.

Two or more cotton members 18 may further be provided and disposed or attached onto the arms 10 (FIGS. 2-4 and 6-7), or disposed or attached onto the heads 16 (FIG. 1), for engaging with and for suitably cleaning the external auditory meatus of the users. The cotton members 18 and the other ends 13 of the arms 10 may thus be resiliently spaced away from each other to resiliently engage with and to suitably clean the external auditory meatus of the users.

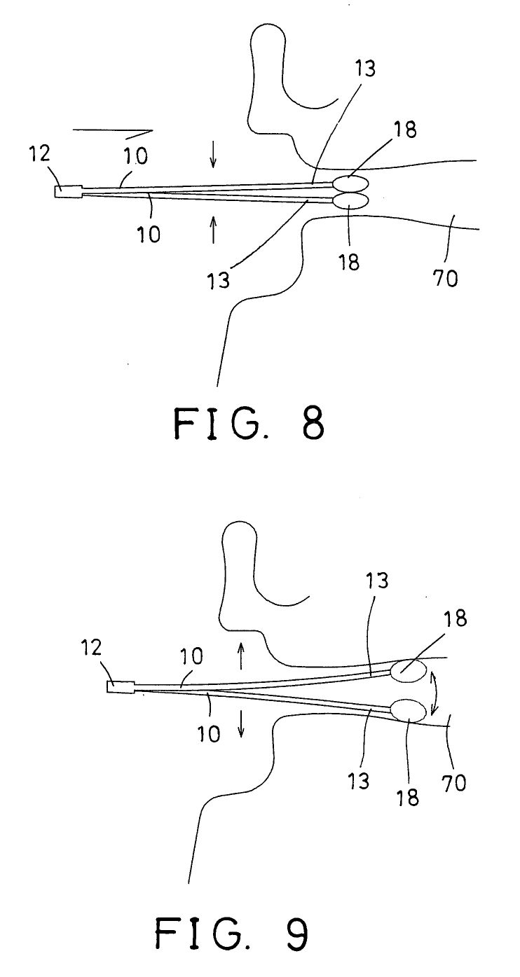

In operation, as shown in FIG. 8, the arms 10 may first be forced toward each other, to force the cotton members 18 and the other ends 13 of the arms 10 toward each other, and to allow the cotton members 18 and the other ends 13 of the arms 10 to be suitably engaged into the external auditory meatus of the users.

As shown in FIG. 9, after the cotton members 18 and the other ends 13 of the arms 10 have been engaged into the external auditory meatus of the users, the arms 10 may be released, to allow the cotton members 18 and the other ends 13 of the arms 10 to be resiliently spaced away from each other to resiliently engage with and to suitably clean the external auditory meatus of the users by the coupling portion or device 12 and/or the spring blades or elements 14.

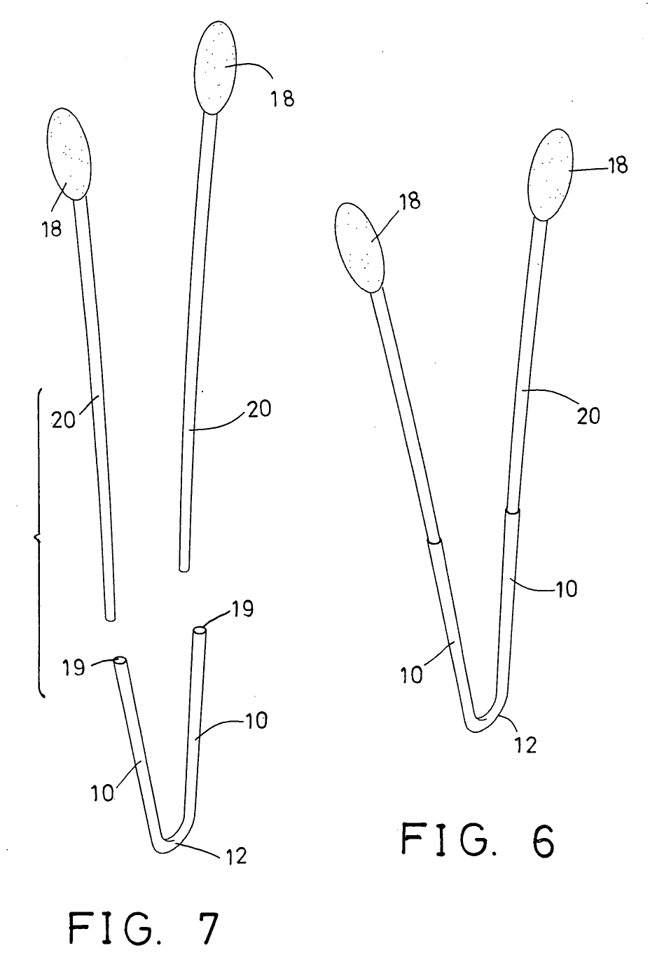

Alternatively, as shown in FIGS. 6 and 7, each of the arms 10 may include a bore 19 formed in a free end portion thereof for receiving the rods 20 of the typical cotton butts, and for allowing the cotton members 18 of the typical cotton butts to be resiliently spaced away from each other by the coupling portion or device 12.

It is to be noted that the cotton members 18 of the ear picking device may be suitably engaged with the external auditory meatus of the users, to allow the external auditory meatus of the users to be suitably cleaned by the cotton members 18 of the ear picking device. In addition, when two or more cotton members 18 are engaged into the external auditory meatus of the users, the cotton members 18 may not be deeply engaged into the external auditory meatus, such that the tympanic membrane may be prevented from being hurt by the ear picking device inadvertently.

Accordingly, the ear picking device in accordance with the present invention includes two or more picking members disposed on two or more spring arms, for resiliently engaging with and cleaning external auditory meatus of users, and for preventing the cottoning members from deeply engaging into the external auditory meatus and for preventing the tympanic membrane from being hurt by the ear picking device inadvertently.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An ear picking device comprising:
a first arm and at least one second arm including one end secured together with a coupling device, to allow said arms to be resiliently coupled together, and for allowing other ends of said arms to be resiliently spaced away from each other, and
a first cotton member and at least one second cotton member attached onto said other ends of said arms, for engaging into external auditory meatus of users, and said first cotton member and said at least one second cotton member being resiliently spaced away from each other by said coupling device, for cleaning the external auditory meatus of users.

2. The ear picking device as claimed in claim 1, wherein said first arm and said at least one second arm each includes an enlarged head provided on said other ends thereof.

3. The ear picking device as claimed in claim 2, wherein each of said heads includes a plurality of cavities formed therein.

4. The ear picking device as claimed in claim 2, wherein each of said heads includes a plurality of projections extended therefrom.

5. The ear picking device as claimed in claim 1 further comprising at least one spring element coupled between said first arm and said at least one second arm, to increase a resilience between said first arm and said at least one second arm.

6. An ear picking device comprising:
a first arm and at least one second arm including one end secured together with a coupling device, to allow said arms to be resiliently coupled together, and for allowing other ends of said arms to be resiliently spaced away from each other, and
said first arm and said at least one second arm each including an enlarged head provided on said other ends thereof for engaging into external auditory meatus of users, and said heads being resiliently spaced away from each other by said coupling device, for cleaning the external auditory meatus of users.

7. The ear picking device as claimed in claim 6 further comprising a first cotton member and at least one second cotton member attached onto said heads of said arms,

8. The ear picking device as claimed in claim 6, wherein each of said heads includes a plurality of cavities formed therein.

9. The ear picking device as claimed in claim 6, wherein each of said heads includes a plurality of projections extended therefrom.

10. The ear picking device as claimed in claim 6 further comprising at least one spring element coupled between said first arm and said at least one second arm, to increase a resilience between said first arm and said at least one second arm.
